(19) United States
(12) Patent Application Publication
(10) Pub. No.: US 2009/0124289 A1
(43) Pub. Date: May 14, 2009

(54) Audio apparatus and external adapter used for the audio apparatus

(75) Inventor: Osamu Nishida, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/291,463

(22) Filed: Nov. 10, 2008

(30) Foreign Application Priority Data
Nov. 12, 2007 (JP) JP 2007-293754

(51) Int. Cl. H04B 1/38

(52) U.S. Cl. 455/559

(57) ABSTRACT

An audio apparatus includes: an audio device arranged to supply an audio signal to a speaker to play an audio; an external adapter connected to the audio device; and a mobile phone device detachably mounted to the external adapter, in which the audio device plays, via the external adapter, an audio signal from the mobile phone device, and the external adapter includes a control unit and in conjunction with mounting and detachment of the mobile phone device with respect to the external adapter, the control unit changes a state of the audio device.

### CROSS REFERENCES TO RELATED APPLICATIONS

The present invention contains subject matter related to Japanese Patent Application JP 2007-293754 filed in the Japanese Patent Office on Nov. 12, 2007, the entire contents of which are incorporated herein by reference.

### BACKGROUND OF THE INVENTION

1. Field of the Invention

The present invention relates to an audio apparatus and an external adapter used for this audio apparatus. In particular, the invention relates to an audio apparatus capable of playing, via an external adapter, an audio signal from a mobile phone device, and an external adapter which is connected to such an audio apparatus and also to which the mobile phone device is mounted.

2. Description of the Related Art

In recent years, functions mounted to a mobile phone device have been gradually expanded and advanced, and a large number of functions such as a camera function, a one-segment broadcasting function, a web browser function, a navigation function based on GPS (Global Positioning System), a moving picture play function, and a music play function are mounted to the mobile phone device as standard functions in a development. Among them, the music play function offers a user a usability superior to that of a normal portable music player as “Chakuuta Furu” (registered trademark) enabling listening to a whole music and an all-you-can-listen music content plan are provided, for example, and further, the music can be downloaded by using the internet wherever the user is and a charge for the music can be paid at the same time with payment to a charge for the use of the mobile phone device.

In a style of listening to the music up to now, a large number of audio contents such as CDs (Compact Disc) are stocked at home, and the audio contents are played with a stationary type audio device for listening. When the user is outside, such a style used to be common that the user brings out a part of the audio contents, for example, a few of the CDs and listens to the music through a portable music player. However, along with the expansion and improvement of the music play functions of the mobile phone device in the above-mentioned manner, a music content is purchased and stored by the mobile phone device. When the user is outside or at home, a style of listening to the music through the mobile phone device is becoming popular. In these circumstances, in a case where the music content is played by the mobile phone device at home, it is common to connect an audio output terminal of the mobile phone device to a stationary type audio device in order to listen to the music with an even higher sound quality.

FIG. 1 illustrates the above-mentioned example. In an audio apparatus composed of an audio device 1 and a pair of left and right speaker boxes 2, a mobile phone device 3 is connected to an audio input terminal of the audio device 1 via a signal code 4 for the listening.

According to such a use method, in order to select a music content to play, as illustrated in FIG. 2, the mobile phone device 3 is operated. On the other hand, to adjust a volume of the audio, a balance between left and right, etc., a volume knob 5, an operation key 6, and the like of the audio device 1 are operated.

In order to facilitate the connection between the audio device 1 and the mobile phone device 3, for example, Japanese Patent Application JP 2007-42931 proposes such a technique that a cradle is connected to the audio device, the mobile phone device is connected to the audio device via this cradle, and music contents stored in a storage unit of the mobile phone device are supplied to the audio device for the playing. Thus, such a system is not particularly high in usability, and there are such drawbacks that an operation process becomes complicated in some cases (see also Japanese Unexamined Patent Application Publication No. 2003-163721).

### SUMMARY OF THE INVENTION

According to an embodiment of the present invention, it is desirable to provide an audio apparatus in which by using an external adapter connected to an audio device, an audio signal such as a music content stored in a mobile phone device is supplied to the audio device, and the music content is played by the audio device.

Also, according to an embodiment of the present invention, it is desirable to provide an audio apparatus with an excellent operability in which an external adapter for exchanging an audio signal and control data with respect to an audio device is connected, and the audio device is controlled by using this external adapter.

In addition, according to an embodiment of the present invention, it is desirable to provide an audio apparatus with an excellent operability in which an external adapter for exchanging an audio signal, control data, and the like is connected to an audio device, and a mobile phone device is controlled by using this external adapter so that troublesome operations are eliminated.

In addition, according to an embodiment of the present invention, it is desirable to provide an audio apparatus in which an external adapter which is connected to an audio device and also to which a mobile phone device is mounted and various functions enabling a user to reduce the number of operation processes are provided.

In addition, according to an embodiment of the present invention, it is desirable to provide an audio apparatus in which an increase in costs on an audio device side is minimized and also an external adapter which improves a usability for a user is connected, and an audio signal of a mobile phone device is supplied to the audio device via this external adapter for the playing.

Further features of the present invention will become apparent from the following description of technical ideas and exemplary embodiments of the present invention.

According to an embodiment of the present invention, there is provided an audio apparatus including: an audio device arranged to supply an audio signal to a speaker to play an audio; an external adapter connected to the audio device; and a mobile phone device detachably mounted to the external adapter, in which the audio device plays, via the external adapter, an audio signal from the mobile phone device, and the external adapter includes control means and in conjunction with mounting and detachment of the mobile phone device with respect to the external adapter, the control means changes a state of the audio device.

In the audio apparatus according to the embodiment of the present invention, when the mobile phone device is mounted to the external adapter, the control means of the external adapter may automatically turn ON a power source of the audio device. In addition, when the mobile phone device is mounted to the external adapter, the control means of the external adapter may automatically change a function of the audio device to a function of playing an audio signal of an audio source of the mobile phone device. In addition, when the mobile phone device is detached from the external adapter, the control means of the external adapter may change a function of the audio device to stop an audio signal of an audio source of the mobile phone device. In addition, when the mobile phone device is detached from the external adapter, the control means of the external adapter may automatically turn OFF a power source of the audio device.

Also, in the audio apparatus according to the embodiment of the present invention, the control means of the external adapter may display an image of an operation guide for the mobile phone device on a monitor of the audio device. In addition, the audio apparatus may further include selection means arranged to select validity or invalidity of the operation of the external adapter for changing the state of the audio device.

Moreover, according to an embodiment of the present invention, there is provided an audio apparatus including: an audio device arranged to supply an audio signal to a speaker to play an audio; an external adapter connected to the audio device; and a mobile phone device detachably mounted to the external adapter, in which the audio device plays, via the external adapter, an audio signal of an audio source from the mobile phone device, and the external adapter includes control means, and in conjunction with a change of a function of the audio device, the control means changes a state of the mobile phone device.

In the audio apparatus according to the embodiment of the present invention, when the function of the audio device is switched to a function of playing the audio source of the mobile phone device, the control means of the external adapter may control the mobile phone device to automatically start playing of the audio source performed by the mobile phone device. In addition, when the function of the audio device is switched to a function other than a function of playing the audio source of the mobile phone device, the control means of the external adapter may control the mobile phone device to automatically stop playing of the audio source performed by the mobile phone device. In addition, when a power source of the audio device is turned OFF, the control means of the external adapter may automatically stop playing of the audio source performed by the mobile phone device.

Also, in the audio apparatus according to the embodiment of the present invention, when the control means of the external adapter allows the mobile phone device to play music, newer pieces of music in terms of the time when being taken into the mobile phone device are sequentially played in order. In addition, the external adapter may include a database of an audio source, and a music list taken in the database may be compared with a music wished to be purchased, and when the music wished to be purchased has been already purchased, that effect may be informed. In addition, the audio apparatus may further include selection means arranged to select validity or invalidity of the operation of the external adapter for changing the state of the audio device.

Moreover, according to an embodiment of the present invention, there is provided an external adapter connected to an audio device and arranged to supply a signal from a mobile phone device to the audio device, the external adapter including: control means arranged to change a function or a state of the audio device in accordance with a change in a state of the mobile phone device.

In the external adapter according to the embodiment of the present invention, the change in the function or the state of the audio device may be turning ON and OFF of a power source to the audio device or playing or stopping of an audio source of the mobile phone device.

Moreover, according to an embodiment of the present invention, there is provided an external adapter connected to an audio device and arranged to supply a signal from a mobile phone device to the audio device, the external adapter including: a control unit arranged to change a function or a state of the mobile phone device in accordance with a change in a state of the audio device.

In the external adapter according to the embodiment of the present invention, the change in the function or the state of the mobile phone device may be playing or stopping of an audio source of the mobile phone device or turning ON and OFF of a power source to the mobile phone device. In addition, while music is played by way of an audio source of the mobile phone device, when the mobile phone device receives an incoming call, the control means of the external adapter may change a genre of a melody for a ringtone of the mobile phone device into an audio source different from a genre of the playing music.

According to a preferred embodiment of the present invention, an external adapter which is capable of connecting/controlling a mobile phone device and also which can be connected to an audio device by using a general-use terminal has at least one of the following functions.

(1) A function of automatically causing an audio device subject to Power On when a mobile phone device is connected to an external adapter.

(2) A function of automatically causing a function of an audio device to a function of playing a music content of a mobile phone device when the mobile phone device is connected to an external adapter.

(3) A function of automatically starting playing when a function of an audio device is changed to a function of playing a mobile phone device.

(4) A function of automatically stopping playing when a function of an audio device is changed to a function other than a function of playing a mobile phone device.

(5) A function of automatically changing a function or causing an audio device subject to Power Off when a mobile phone device is detached from an external adapter.

(6) A function of automatically stopping music content playing of a mobile phone device when an audio device is subjected to Power Off.

(7) A function of switching validity/invalidity of the above-mentioned functions of (1) to (6).

(8) A function of suppressing an increase in costs on an audio device side by realizing the above-mentioned functions on an external adapter side.

According to the above-mentioned embodiment, only by connecting the mobile phone device to the external adapter, the audio device can be automatically subjected to Power On, the function of the audio device can be automatically changed, and the audio source of the mobile phone device can be automatically played. Therefore, it is possible to significantly reduce the number of operation processes up until the user starts listening to the song of the music content written in the storage unit of the mobile phone device.

Also, as the user only subjects the audio device to Power Off and switches the function of the audio device, it is possible to automatically stop the playing of the mobile phone device. Therefore, it is possible to significantly reduce the number of operation processes for the user, and further, it is possible to avoid wasting of a battery of the mobile phone device.

In addition, as the user only detaches the mobile phone device from the external adapter, it is possible to automatically subject the audio device to Power Off, and the functions of the audio set can be automatically switched. Therefore, it is possible to reduce the number of operation processes for the user.

Moreover, by making it possible to independently switch validity/invalidity of the respective functions, various use cases for the users can be dealt with.

By realizing the above-mentioned functions by way of software of the mobile phone device control micro computer of the external adapter, the above-mentioned functions are not realized on the audio device. The audio device can be thus designed without depending on the functions of the external adapter. Therefore, without impairing the general versatility of the audio device, it is possible to suppress the cost up.

According to the embodiment of the present invention, the audio apparatus includes the audio device arranged to supply the audio signal to the speaker and play the audio, the external adapter connected to the audio device, and the mobile phone device detachably mounted to the external adapter, in which the audio signal from the mobile phone device is played via the external adapter, the external adapter includes the control unit, and the control unit changes the state of the audio device in conjunction with mounting and detachment of the mobile phone device with respect to the external adapter.

Therefore, according to such an audio apparatus, the control unit can change the state of the audio device in conjunction with mounting and detachment of the mobile phone device with respect to the external adapter. Thus the operation on the audio device performed by the user can be omitted, and it is possible to automatically turn ON/OFF of the power source with respect to the audio device and change the functions of the audio device, for example.

Also, according to the embodiment of the present invention, the audio apparatus includes the audio device arranged to supply the audio signal to the speaker and play the audio, the external adapter connected to the audio device, and the mobile phone device detachably mounted to the external adapter, in which the audio signal of the audio source from the mobile phone device is played via the external adapter by the audio device, the external adapter includes the control unit, and the state of the mobile phone device is changed in conjunction with the change in the function of the audio device.

Therefore, according to such an audio apparatus, when the function of the audio device is changed, the control unit of the external adapter changes the state of the mobile phone device in conjunction with the change, and thus the operation of the mobile phone device can be omitted. For example, in conjunction with Power Off of the audio device or the switching of the function, it is possible that the playing of the mobile phone device is automatically stopped or the power source to the mobile phone device is turned OFF.

### BRIEF DESCRIPTION OF THE DRAWINGS

FIG. 1 is a block diagram of an operation for a connection between an audio apparatus and a mobile phone device in related art;

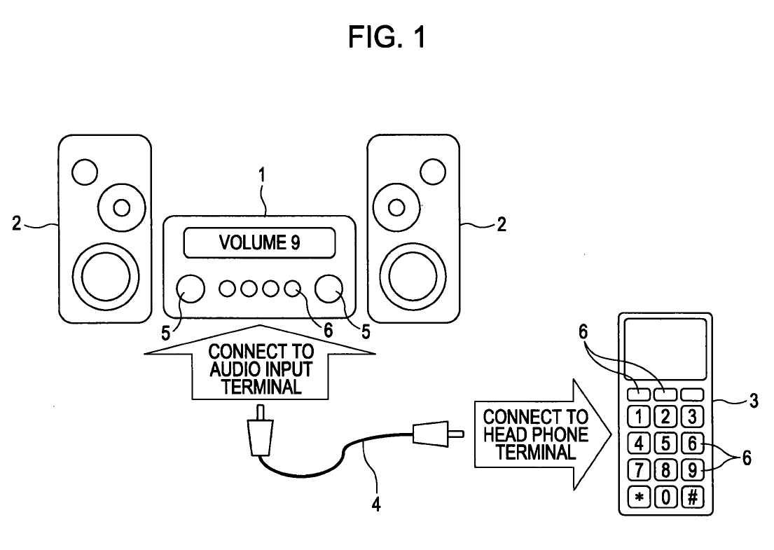

FIG. 2 is a block diagram of operations for an audio device and a mobile phone device in the same system;

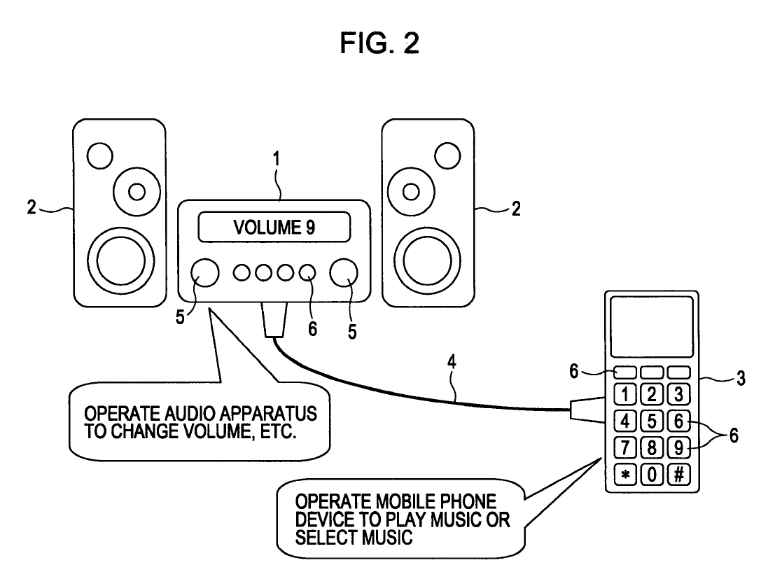

FIG. 3 is a block diagram of a system configuration according to an embodiment of the present invention;

FIG. 4 is a circuit diagram of a circuit configuration of an audio device in the same system;

FIG. 5 is a flowchart of a Power On operation on the audio device;

FIG. 6 is a flowchart of demanding a function change on the audio device;

FIG. 7 is a flowchart of an automatic play/automatic stop operation on the mobile phone device;

FIG. 8 is a flowchart of operations for a Power Off function and a function change function of the audio device;

FIG. 9 is a flowchart of play and stop operations of the mobile phone device at the time of Power Off;

FIG. 10 is a front view illustrating a display of an operation guide of the mobile phone device by an external monitor;

FIG. 11 is a flowchart of an operation for the same operation guide;

FIG. 12 is a flowchart of an operation for sequentially playing the music in terms of the time when being taken into the mobile phone device;

FIG. 13 is a flowchart of an operation for setting a melody of a ringtone as a melody in a genre different from the playing music; and

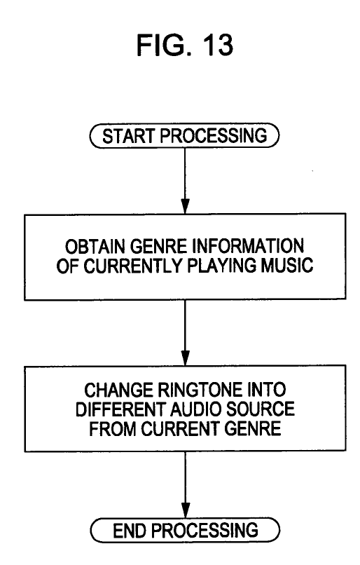

FIGS. 14A and 14B are flowcharts for preventing a redundant purchase in a case where the music has been already purchased.

### DESCRIPTION OF THE PREFERRED EMBODIMENTS

Hereinafter, embodiments of the present invention will be described with reference to the accompanying drawings.

### 1. System Configuration

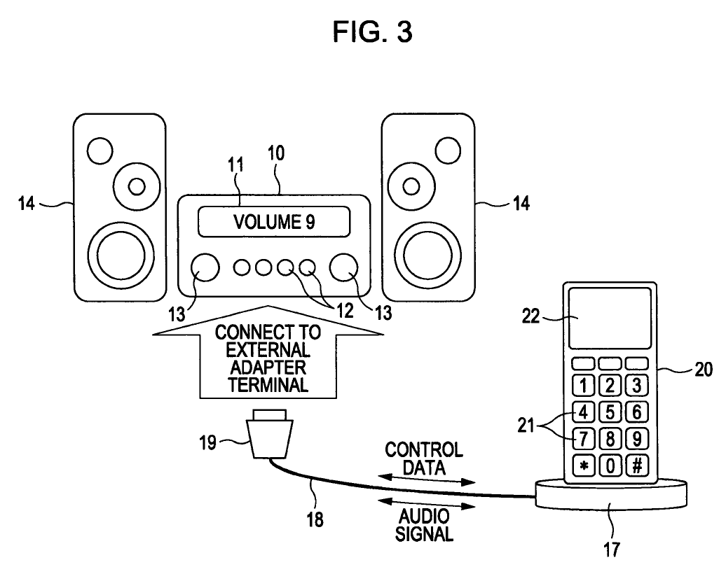

FIG. 3 illustrates an entire configuration of an audio apparatus according to the present embodiment, and this audio apparatus is provided with an audio device 10 as a core device. The audio device 10 may be, for example, an audio device configured by mainly using an optical disc player. On a front panel of the audio device, a display device 11 is mounted, and on a lower side thereof, a plurality of operation buttons 12 and a volume knob 13 are provided. In addition, the audio device 10 is provided with a pair of left and right speaker boxes 14, and an audio signal is played by using a plurality of speakers in the speaker boxes 14.

An external adapter 17 is connected to the audio device 10. The external adapter 17 is provided with a signal cable 18, and a connector plug 19 connected to an end part of the signal cable 18 is connected to the audio device 10. Then, a mobile phone device 20 is placed on the external adapter 17, and a signal from the mobile phone device 20 is supplied to the audio device 10 via the external adapter 17 and the signal cable 18. It should be noted that on a front face side of the mobile phone device 20, an operation key 21 and a display 22 are provided.

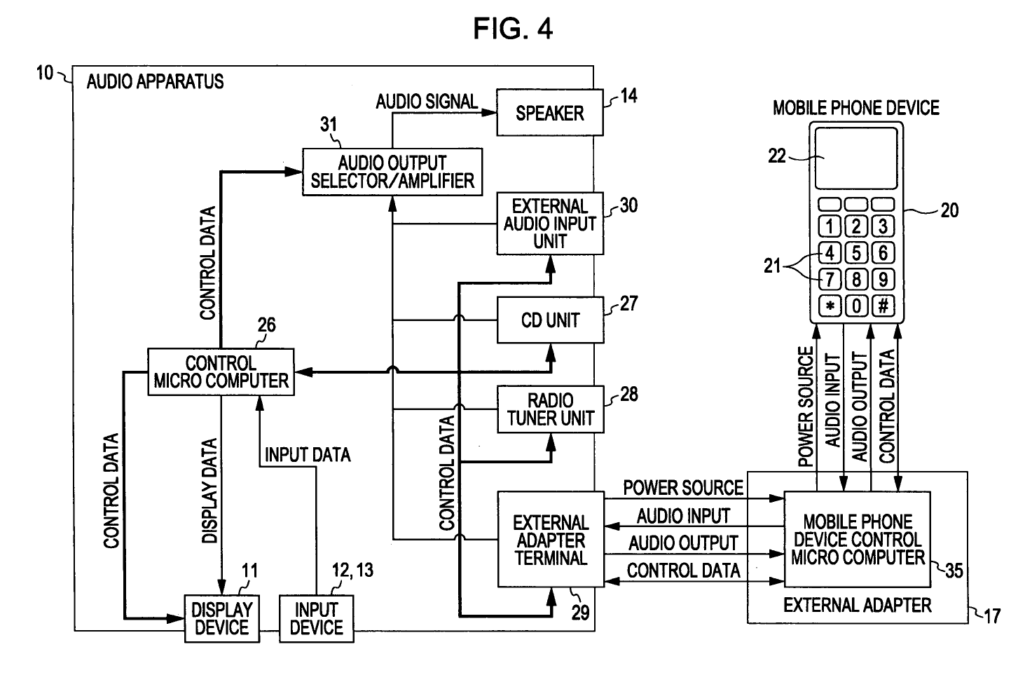

FIG. 4 illustrates a circuit configuration of the audio device 10, and the audio device 10 is provided with a control micro computer 26. Also, the control micro computer 26 is connected to a disc player 27, a radio tuner 28, a terminal 29 for the external adapter connection, and the like functioning as audio sources. Furthermore, the control micro computer 26 is connected to an external audio input unit 30. Then, by using the control micro computer 26, an audio output selector/amplifier 31 is controlled. An output terminal of the audio output selector/amplifier 31 is connected to the speaker 14. In addition, the control micro computer 26 is connected to the display device 11 and input devices 12 and 13.

An external adapter terminal 29 is connected to the external adapter 17. The mobile phone device 20 is detachably mounted to the external adapter 17. Between the mobile phone device 20 and the external adapter 17, audio input, audio output, and exchange of control data are performed. Furthermore, by supplying the power source from the external adapter 17, it is possible to charge a secondary battery of the mobile phone device 20. In addition, the external adapter 17 performs the audio input, the audio output, and the exchange of control data with the external adapter terminal 29 of the audio device 10, and also the power source is supplied from the audio device 10 to the external adapter 17. Then, the external adapter 17 is provided with a mobile phone device control micro computer 35 arranged to process the audio input, the audio output, and the control data. The mobile phone device control micro computer 35 not only controls the mobile phone device 20 but also controls the audio device 10. Therefore, the mobile phone device control micro computer 35 constitutes a control unit realizing extremely important functions.

### 2. Outline of an Entire Operation

A description will be given of an outline of a case as an example in which in response to an operation from the audio device 10, a music content that is an audio source of the mobile phone device 20 is played. The external adapter 17 is connected to the audio device 10, and also the mobile phone device 20 is connected to the external adapter 17. When a play button functioning as the input device 12 of the audio device 10 is pressed, the information is input to the control micro computer 26 as input data. At this time, in a case where the audio device 10 is an external adapter function, the control micro computer 26 sends control data for playing to the external adapter 17.

After receiving the playing control data from the audio device 10, the mobile phone device control micro computer 35 in the external adapter 17 converts the playing control data from the audio device 10 into playing control data for the mobile phone device 20 to be sent to the mobile phone device 20. The mobile phone device 20 receiving this data informs the mobile phone device control micro computer 35 that the playing is resumed. The mobile phone device control micro computer 35 informs the control micro computer 26 of the audio device 10 that playing of the mobile phone device 20 is started. In order to output the audio signal of the mobile phone device 20 from the speaker 14, the audio output selector/amplifier 31 is switched to the mobile telephone device connection unit, and an audio volume is adjusted by using the audio output amplifier 31. Furthermore, playing information of the mobile phone device 20 is sent as display data to the display device 11 for displaying the information.

With the adoption of such a system, a signal protocol between the audio device 10 and the external adapter 17 is set universal, and even when the external adapter 17 is not the mobile phone device 20 but, for example, is the external adapter for the connection of the portable music player or the like, without paying attention to the state, the audio device 10 can control the device connected to the external adapter 17.

3. Automatic Power On Function for the Audio Device 10 when the Mobile Phone Device 20 is Mounted and Connected to the External Adapter 17

An operation of connecting the mobile phone device 20 to the external adapter 17 is performed by the user in a case where the music stored in the storage unit of the mobile phone device 20 is wished to be listened to. Therefore, even when the audio device 10 is in the Power Off state, if the audio device 10 is automatically put into the Power On state, the number of operations performed by the user is reduced, which is convenient. In view of the above, according to the present embodiment too, only by connecting the mobile phone device 20 to the external adapter 17, such a function is provided that the audio device 10 is automatically put into the Power On state.

The control micro computer 26 of the audio device 10 is regularly in a communicable state with the external adapter 17. At this time, the external adapter 17 sends the control data to the mobile phone device 20. However, in a case where the mobile phone device 20 is not connected to the external adapter 17, a reply to the control data is not obtained. Thus, the mobile phone device control micro computer 35 of the external adapter 17 determines that the mobile phone device 20 is not connected.

Next, when the mobile phone device 20 is connected to the external adapter 17, the reply to the control data from the mobile phone device control micro computer 35 is performed the mobile phone device 20, and thus the mobile phone device control micro computer 35 determines that the mobile phone device 20 is connected. Then, in response to the connection of the mobile phone device 20, the mobile phone device control micro computer 35 notifies the audio device 10 of a Power On request. On the audio device 10 receiving the notification of the Power On request, a Power On processing is performed. In the Power On processing, an initialization processing for the audio device 10 itself, a processing of outputting an audio of the function whose audio is changed to the audio output selector/amplifier 31, the Power On processing on the respective devices such as the operation of sending display data to the display device 11 for the Power On display are performed.

Through the above-mentioned processing, as the user only connects the mobile phone device 20 to the external adapter 17, the audio device 10 is automatically put into the Power On state.

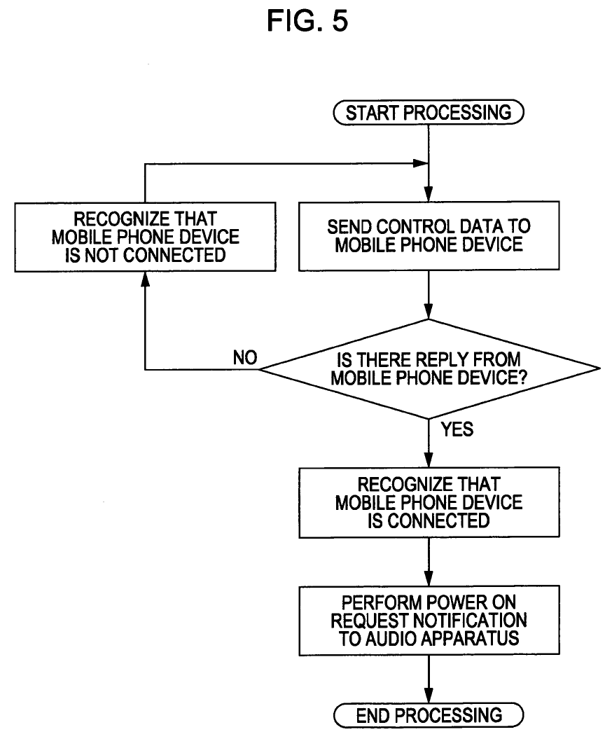

FIG. 5 is a flowchart of the operation for the above-mentioned processing performed by the mobile phone device control micro computer 35 of the external adapter 17. In this flowchart, it is determined as to whether there is a reply after the control data is sent to the mobile phone device 20, and in a case where there is a reply, it is recognized that the mobile phone device 20 is connected, and the audio device 10 is notified of the Power On request. It should be noted that in a case where there is no reply from the mobile phone device, the operation of sending the control data is repeatedly performed.

4. Function of Automatically Changing the Function of the Audio Device 10 into the Function of Playing the Mobile Phone Device 20 when the Mobile Phone Device 20 is Connected to the External Adapter 17

Similarly to the above-mentioned function of 3, as the user only connects the mobile phone device 20 to the external adapter 17, the function of the audio device 10 is automatically switched into the playing function of the mobile phone device 20. Thus, the number of operations performed by the user is reduced, which is convenient. In view of the above, according to the present embodiment, the function of automatically changing the function of the audio device 10 into the playing function of the mobile phone device 20 by only connecting the mobile phone device 20 to the external adapter 17 is added.

Similarly to the above-mentioned function of 3, the mobile phone device control micro computer 35 determines that the mobile phone device 20 is connected, and in response to the connection of the mobile phone device 20, the control micro computer 26 on the audio device 10 side is notified of the request to change the function to the mobile phone function. The control micro computer 26 of the audio device 10 receiving the notification performs the function change processing. In the function change processing, processing at the time of the function change are performed on the respective devices including the processing of outputting the audio of the function whose audio is changed to the audio output selector/amplifier 31, the operation of sending the display data to the display device 11 for the function change display, and the like.

Through the above-mentioned processing, as the user connects the mobile phone device 20 to the external adapter 17, it is possible to change the function automatically.

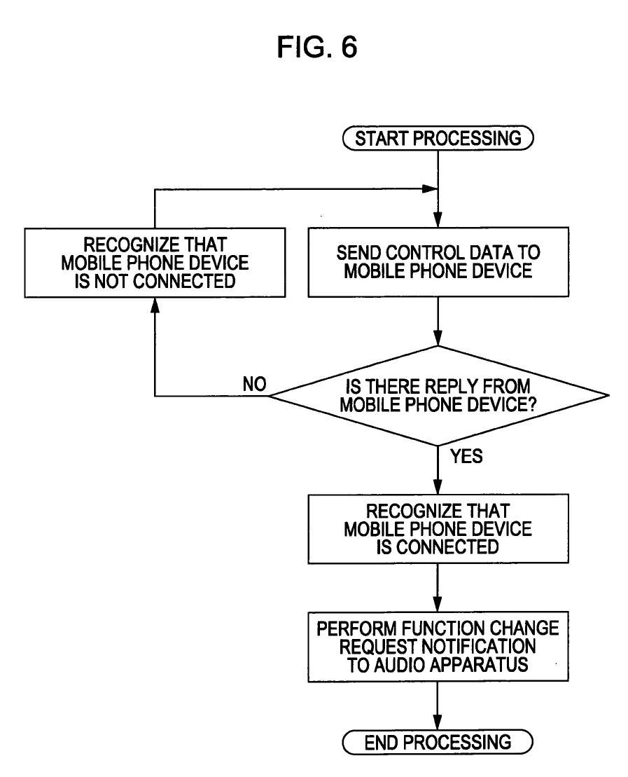

FIG. 6 is a flowchart of the above-mentioned operation. This operation is realized as software of the mobile phone device control micro computer 35 of the external adapter 17. After the control data is sent to the mobile phone device 20, in a case where there is a reply from the mobile phone device 20, it is recognized that the mobile phone device 20 is connected to the external adapter 17, and the audio device 10 is notified of the function change request. In a case where there is no reply from the mobile phone device 20, the operation of sending the control data to the mobile phone device 20 is repeatedly performed.

5. Function of Automatically Starting Playing when the Function of the Audio Device 10 is Changed to the Function of Playing the Mobile Phone Device 20

The user changes the function of the audio device 10 to the function of playing the mobile phone device 20 in a case where the music content stored in the storage unit of the mobile phone device 20 is wished to be listened to. Therefore, as the playing of the mobile phone device 20 is automatically started, the number of operations performed by the user is reduced, which is convenient. According to the present embodiment, the function of automatically starting the playing of the mobile phone device 20 in a case where the function of the audio device 10 is changed to the function of playing the mobile phone device 20 is added.

When the operation of changing the function of the audio device 10 to the function of playing the music content of the mobile phone device 20 is performed, the control micro computer 26 on the audio device 10 side starts the function change processing. In the function change processing, processings at the time of the function change are performed on the respective devices including the processing of outputting the audio of the function whose audio is changed to the audio output selector/amplifier 31, the operation of sending the display data to the display device 11 for the function display change, and the like. At this time, the control micro computer 26 notifies the external adapter 17 that the function is changed. In a case the function is the function for the external adapter 17, the mobile phone device control micro computer 35 of the external adapter 17 sends the playing control data to the mobile phone device 20.

Through the above-mentioned processing, as the user only performs the operation for changing the mobile phone device 20 into the function change operation of the audio device 10, it is possible to automatically start the playing of the music content of the mobile phone device 20. It should be noted that while this operation is performed at the same time as the above-mentioned functions 3 and 4, by only connecting the mobile phone device 20, it is possible to automatically play the music by the mobile phone device 20.

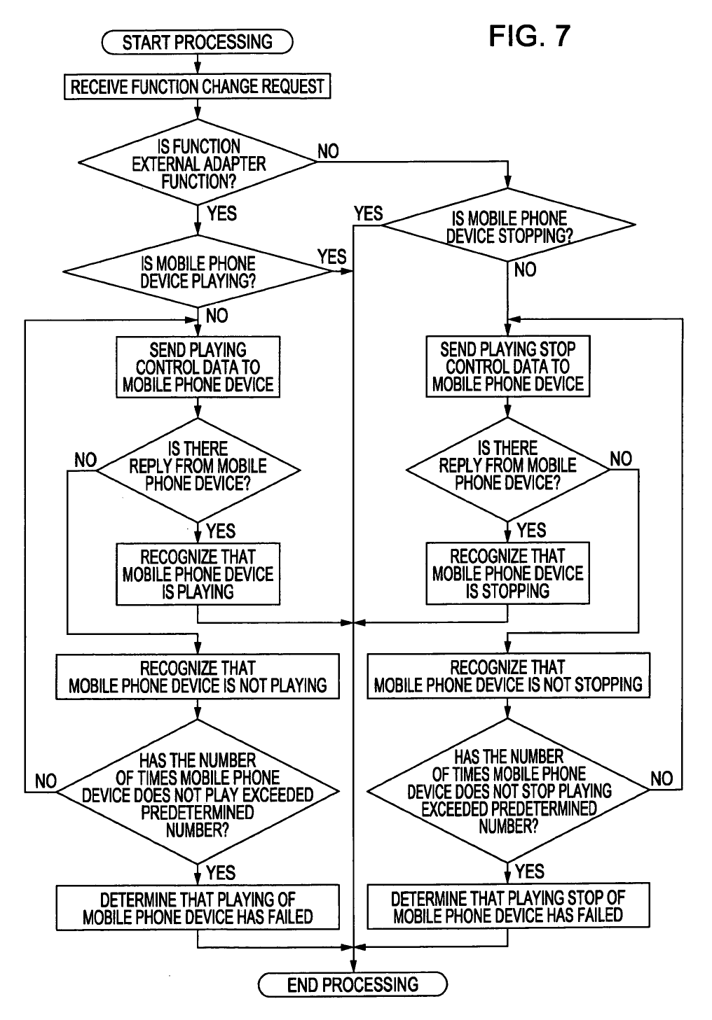

This operation corresponds to a part on the left part in a flowchart of FIG. 7. The mobile phone device control micro computer 35 receiving the function change notification determines whether the function is the external adapter function, and also determines, in a case where the function is the external adapter function, whether the mobile phone device 20 is playing. In a case where the mobile phone device 20 is not playing, the mobile phone device control micro computer 35 sends the playing control data to the mobile phone device 20. In a case where a reply signal from the mobile phone device 20 is received, it is determined that the mobile phone device 20 is playing. It should be noted that in a case where there is no reply from the mobile phone device 20, it is determined whether there is a reply after the control data is sent by the predetermined number of times, and in a case where the operation exceeds the predetermined number of times, it is determined that the playing of the mobile phone device 20 has failed.

6. Function of Automatically Stop Playing in a Case where the Function of the Audio Device 10 is Changed to a Function other than the Function of Playing the Mobile Phone Device 20

In a case where the audio device 10 is a CD function for listening to a CD or a tuner function for listening to the radio tuner 28, the music is played by way of the respective functions of the audio device 10. On the other hand, in a case where the music content of the mobile phone device 20 is listened to, the listening is performed with the function of using the mobile phone device. In a state where the music content of the mobile phone device 20 is listened to, the operation performed by the user of changing the audio device 10 to another function corresponds to an intended operation of listening to music of another function and an operation of stopping the music played by the mobile phone device 20. Therefore, when the playing of the mobile phone device 20 is automatically stopped, the number of operations performed by the user is reduced, which is convenient. According to the present embodiment, the function of automatically stopping the playing of the mobile phone device 20 by changing the function of the audio device 10 to a function other than the function of playing the mobile phone device 20 is added.

When the music is played by the mobile phone device 20, in a case where the operation of changing the audio device 10 to a function other than the function of playing the mobile phone device 20, the control micro computer 26 of the audio device 10 starts the function change processing similarly to the above-mentioned function of 5, and notifies the external adapter 17 that the function is changed. the mobile phone device control micro computer 35 of the external adapter 17 sends the playing stop control data to the mobile phone device 20 in a case where the function is other than a function for the external adapter 17. Through the above-mentioned processing, as the user only performs the operation of changing the function of the audio device 10, the playing of the music content of the mobile phone device 20 can be automatically stopped. Therefore, it is possible to suppress the wasteful battery consumption of the mobile phone device 20.

This operation corresponds to an operation on the right half of the flowchart illustrated in FIG. 7 and is achieved by software of the mobile phone device control micro computer 35 of the external adapter 17. When the mobile phone device control micro computer 35 receives the function change notification, it is determined whether this notification is the external adapter function. In a case where this notification is not the external adapter function, it is determined whether the mobile phone device is stopping. In a case where the mobile phone device is not stopping, the playing stop control data is sent to the mobile phone device 20. After that, there is a reply from the mobile phone device 20, it is recognized that the mobile phone device 20 stops. It should be noted that in a case where there is no reply from the mobile phone device 20, the operation is repeated by the predetermined times, and even after that, in a case where no reply is obtained, it is determined that stopping the playing of the mobile phone device 20 has failed.

7. Function of Automatically Changing the Function or Subjecting the Audio Device 10 to Power Off when the Mobile Phone Device 20 is Detached from the External Adapter 17

The operation performed by the user of detaching the mobile phone device 20 from the external adapter 17 corresponds to a case where listening to the song of the music content of the mobile phone device 20 is to be stopped or a case where another music source is wished to be played. Therefore, when the mobile phone device 20 is detached from the external adapter 17, such a function is useful that the function change of the audio device 10 is automatically performed or Power Off of the audio device 10 is automatically performed, for example.

While the mobile phone device 20 plays music, when the mobile phone device 20 is detached, the reply to the control data which is regularly sent from the mobile phone device control micro computer 35 of the external adapter 17 disappears, and thus the mobile phone device control micro computer 35 recognizes that the mobile phone device 20 is detached. Next, in accordance with “a processing previously set by the user which is performed when the mobile phone device 20”, the Power Off request or the function change request notification is performed for the audio device 10. Through the above-mentioned processing, as the user only detaches the mobile phone device 20 from the external adapter 17, it is possible to automatically perform Power Off of the audio device 10 or the function change.

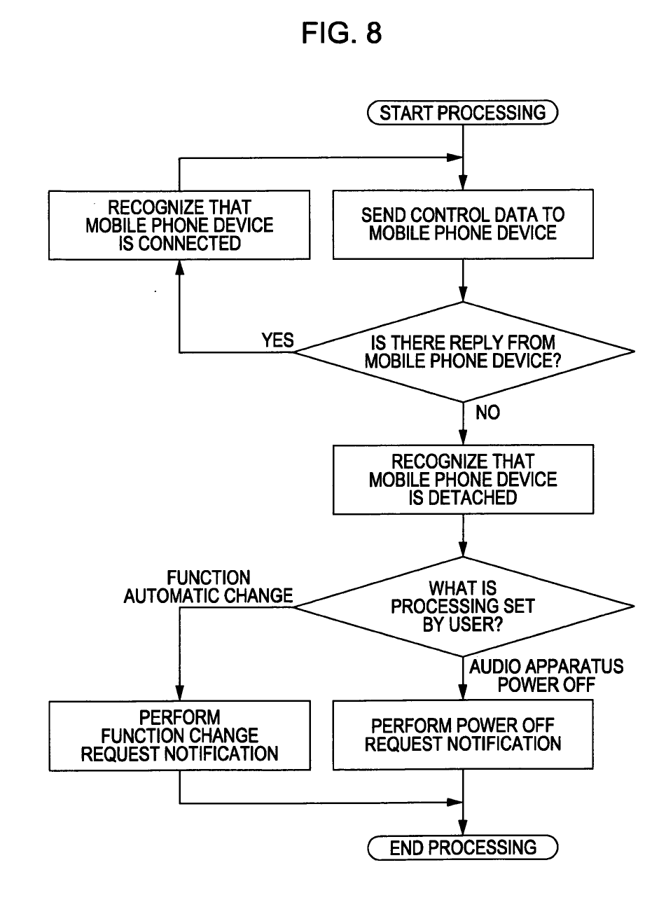

This operation corresponds to a flowchart illustrated in FIG. 8 and is performed as a control operation for the mobile phone device control micro computer 35 of the external adapter 17. The mobile phone device control micro computer 35 sends the control data to the mobile phone device 20 and determines whether there is a reply from the mobile phone device 20. In a case where there is no reply, it is determined that the mobile phone device 20 is detached from the external adapter 17. It should be noted that in a case where there is a reply from the mobile phone device 20, it is recognized that the mobile phone device is connected.

When it is recognized that the mobile phone device 20 is detached from the external adapter 17, in a case where the processing set by the user is Power Off of the audio device 10, the mobile phone device control micro computer 35 performs the Power Off request notification on the audio device 10. In contrast to this, in a case where the processing set by the user is the function automatic change, the mobile phone device control micro computer 35 performs function change notification on the audio device 10.

8. Function of Automatically Stopping Playing of the Music Content of the Mobile Phone Device 20 when the Audio Device 10 is put into the Power Off State

By putting the audio device 10 into the Power Off state, when the listening to the music is wished to be ended, if the music play of the mobile phone device 20 is continued, the secondary battery of the mobile phone device 20 continues to be consumed. Thus, there is a possibly that the secondary battery is discharged, which is inconsiderate for the user. In view of the above, according to the present embodiment, the function of automatically stopping the playing of the mobile phone device 20 by putting the audio device 10 into the Power Off state is added.

While the music is played by the mobile phone device 20, when the Power Off operation of the audio device 10 is performed, the control micro computer 26 performs the Power Off processing. In the Power Off processing, processings at the time of Power Off are performed on the respective devices including a processing of muting the audio with respect to the audio output selector/amplifier 31, a processing of sending display data to the display device 11 for performing an end display, and the like. At this time, the control micro computer 26 notifies the external adapter 17 that the Power Off processing is being performed. The mobile phone device control micro computer 35 of the external adapter 17 receives this notification and sends the playing stop control data to the mobile phone device 20. After it is confirmed that the mobile phone device stops the playing, the mobile phone device control micro computer 35 provides a Power Off permit notification to the audio device 10. Through the above-mentioned operation, as the user only performs the Power Off operation of the audio device 10, it is possible to automatically stop the playing of the music content of the mobile phone device 20, and the wasteful battery consumption can be suppressed.

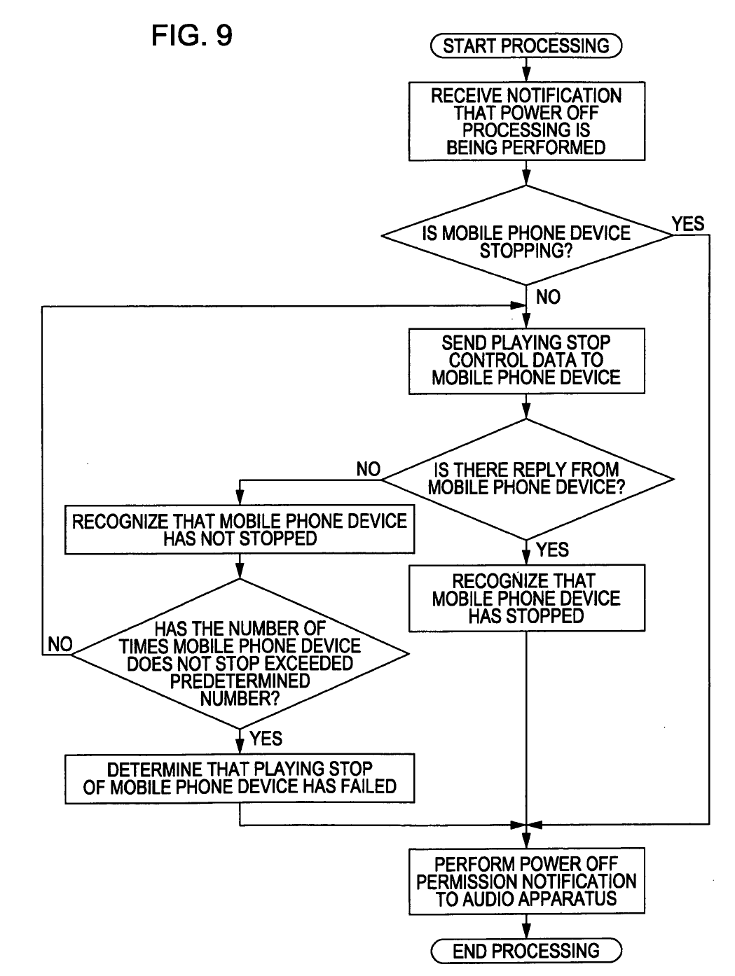

FIG. 9 is a flowchart of the above-mentioned operation, which is realized by software of the mobile phone device control micro computer 35 of the external adapter 17. In a case where the control micro computer 35 receives The Power Off processing notification, it is determined whether the mobile phone device 20 is stopping. In a case where the mobile phone device 20 is not stopping, the playing stop control data is sent to the mobile phone device 20. Then, in a case where there is a reply from the mobile phone device 20, it is recognized that the mobile phone device 20 stops the playing, and after that, a Power Off permit notification is performed for the audio device 10. It should be noted that in a case where there is no reply from the mobile phone device 20, sending of the control data is repeatedly performed, and even when the number of times when no reply obtains from the mobile phone device 20 exceeds a predetermined value, it is determined that stopping the playing of the mobile phone device 20 has failed.

### 9. Function of Switching Validity/Invalidity of the Functions 3 to 8

Some users do desire that not all the above-mentioned functions 3 to 8 are effectively operated. Therefore, a function of setting a menu for switching validity/invalidity of the respective functions is added. For this operation, on the audio device 10 side or the external adapter 17 side, a display device for displaying the menu and an input device for operating the menu are provided. Operation buttons used for the input device for operating the menu include the following buttons, for example.

(1) A “MENU” button for entering into or exiting from the menu

(2) “↑” and “↓” buttons for selecting menu items

(3) An “ENTER” button for determining the menu item

Next, the following table represents the items and options.

TABLE 1

Automatic Power On of the audio device when the mobile
phone device is connected
→ [Set, Cancel]
Automatically set the mobile phone function when the
mobile phone device is connected
→ [Set, Cancel]
Automatically stop playing when the function is changed to
the mobile phone function
→ [Set, Cancel]
Automatically stop playing when the function is changed to
a function other than the mobile phone function
→ [Set, Cancel]
Processing to be automatically performed when the mobile
phone device is detached
→ [Power Off, Set to another function, Do nothing]
Automatically stop playing of the mobile phone device at
the time of Power Off
→ [Set, Cancel]

As illustrated in the above table, for the respective items including the function of automatically setting the audio device 10 into the Power On state when the mobile phone device 20 is connected, the function of automatically setting the mobile phone function when the mobile phone device 20 is connected, the function of automatically start playing when the function is changed to the mobile phone function, the function of automatically stopping the playing when the function is changed to a function other than the mobile phone function, the processing to be automatically performed when the mobile phone device 20 is detached, at the time of Power Off, the function of automatically stopping the playing of the mobile phone device, and the like, validity/invalidity of the function can be previously switched, and therefore, the user can achieve the preferred operations.

### 10. Display an Image of the Mobile Phone Device 20 and an Operation Guide on a Monitor Connected to the Audio Device 10

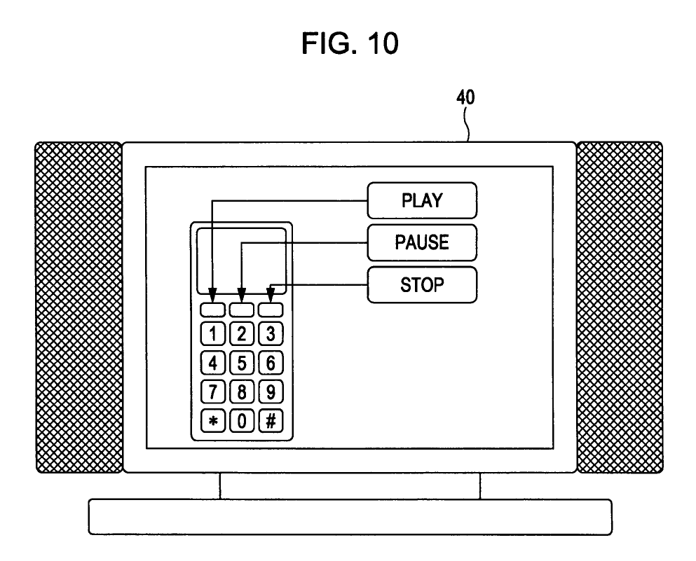

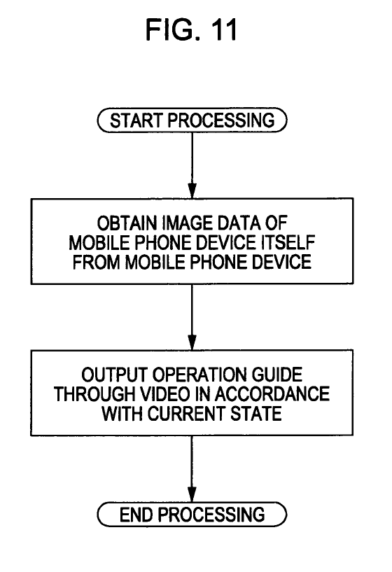

In a case where the mobile phone device 20 is mounted to the external adapter 17, by using a help function displayed on an external monitor 40 of the audio device 10 (refer to FIG. 10), an image of the mobile phone device 20 and an operation guide are displayed. As illustrated in FIG. 11, according to this function, the image data of the mobile phone device 20 itself is obtained from the mobile phone device 20 and supplied via the external adapter 17 to the audio device 10. With the external monitor 40 connected to the audio device 10, the operation guide is output in accordance with the current state by way of video.

11. Playing Newer Pieces of Music in Terms of the Time when being Taken into the Mobile Phone Device when the Music of the Connected Mobile Phone Device 20 is Played

In a case where the mobile phone device 20 is utilized as the music player, a large number of music contents are written in a semiconductor memory or a hard disc drive of the mobile phone device 20 in advance. At this time, if newer pieces of music in terms of the time when being taken into are sequentially played in turn, the music contents with fresh interest to listen to are sequentially played, which is convenient for the user.

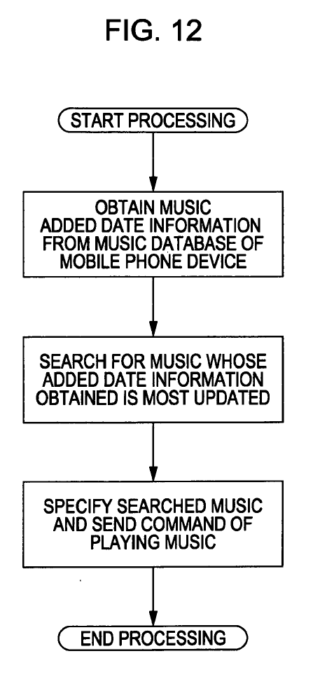

In view of the above, as illustrated in FIG. 12, by using the database provided to the external adapter 17, the added date information of the music is obtained, and the music whose added date information is most updated is searched for. Then, the searched music is specified, and the mobile phone device control micro computer 35 of the external adapter 17 sends a command of playing the music to the mobile phone device 20. Therefore, the mobile phone device 20 sequentially plays the music contents from the newer obtaining date to the order obtaining date.

12. Change the Ringtone to a Music in a Different Genre from the Playing Music in a Case where an Incoming Call is Received when the Music is being Played

While the mobile phone device 20 is utilized as the audio source and the music contents recorded in the storage medium is being played, when the mobile phone device 20 receives an incoming call, a ringtone is generated. At this time, in a case where a melody of the ringtone of the mobile phone device 20 is the same genre as a melody of the playing music, it is sometimes difficult to distinguish whether the sound is the ringtone or the playing sound of the music content. In view of the above, according to the present embodiment, the genre information of the currently playing music is obtained, and also the melody of the ringtone when the incoming call is received is changed to the music different from the audio source in the genre of the playing music so that the incoming call notification is performed. Therefore, the user can distinguish the playing sound from the ringtone and recognize the incoming call with certainty.

13. Notify a Redundant Purchase in a Case where the Music has been already Purchased at the Time of Purchasing

In a case where a large number of music contents are obtained by the mobile phone device 20, there is a possibility that the music may be redundantly purchased, and a wasteful expense may be spent. Therefore, regarding the already purchased music content, it is preferred to recognize the previous purchase and not to purchase the same music again.

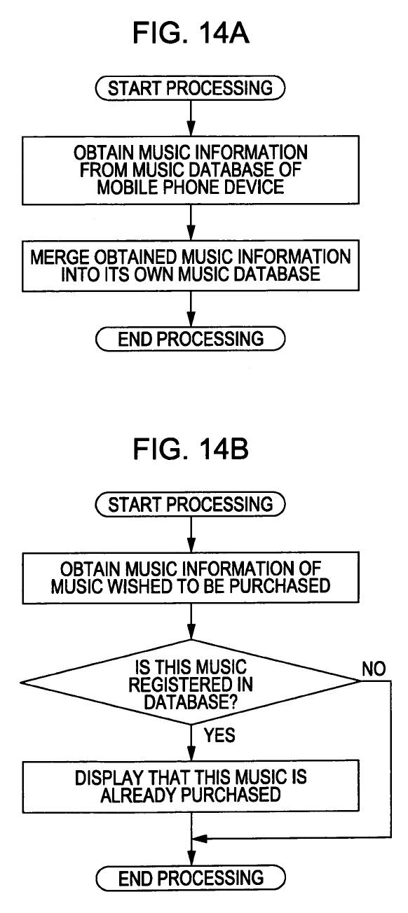

In view of the above, as illustrated in FIG. 14A, the external adapter 17 obtains music information from the music database of the mobile phone device 20, and also merges the thus obtained music information with the user's own music database.

On the other hand, as illustrated in FIG. 14B, the mobile phone device 20 obtains information on music to be purchased to determine whether the music is already registered in the database of the external adapter 17. Then, in a case where the music is already purchased, that effect is displayed on the display unit 22 or the like, so that the user is notified. Therefore, the user can avoid the waste of the redundant purchase of the already purchased music content, and the wasteful spending can be prevented.

The present invention has been described by way of the embodiments with reference to the drawings in the above, but the present invention is not limited to the above-mentioned embodiments, and various modifications can be made within the technical idea of the present invention. For example, various changes can be made on the system configuration and the like of the audio device 10 according to the above-mentioned embodiments. In addition, the audio device 10 itself may be connected to a television receiver, and this television receiver may be utilized as a monitor.

It should be understood by those skilled in the art that various modifications, combinations, sub-combinations and alterations may occur depending on design requirements and other factors insofar as they are within the scope of the appended claims or the equivalents thereof.

What is claimed is:

1. An audio apparatus comprising:
an audio device arranged to supply an audio signal to a speaker to play an audio;
an external adapter connected to the audio device; and
a mobile phone device detachably mounted to the external adapter,
wherein the audio device plays, via the external adapter, an audio signal from the mobile phone device, and
wherein the external adapter includes control means, and in conjunction with mounting and detachment of the mobile phone device with respect to the external adapter, the control means changes a state of the audio device.

2. The audio apparatus according to claim 1, wherein when the mobile phone device is mounted to the external adapter, the control means of the external adapter automatically turns ON a power source of the audio device.

3. The audio apparatus according to claim 1, wherein when the mobile phone device is mounted to the external adapter, the control means of the external adapter automatically changes a function of the audio device to a function of playing an audio signal of an audio source of the mobile phone device.

4. The audio apparatus according to claim 1, wherein when the mobile phone device is detached from the external adapter, the control means of the external adapter changes a function of the audio device to stop an audio signal of an audio source of the mobile phone device.

5. The audio apparatus according to claim 1, wherein when the mobile phone device is detached from the external adapter, the control means of the external adapter automatically turns OFF a power source of the audio device.

6. The audio apparatus according to claim 1, wherein the control means of the external adapter displays an image of an operation guide for the mobile phone device on a monitor of the audio device.

7. The audio apparatus according to claim 1, further comprising:
selection means arranged to select validity or invalidity of the operation of the external adapter for changing the state of the audio device.

8. An audio apparatus comprising:
an audio device arranged to supply an audio signal to a speaker to play an audio;
an external adapter connected to the audio device; and
a mobile phone device detachably mounted to the external adapter,
wherein the audio device plays, via the external adapter, an audio signal of an audio source from the mobile phone device, and
wherein the external adapter includes control means, and in conjunction with a change of a function of the audio device, the control means changes a state of the mobile phone device.

9. The audio apparatus according to claim 8, wherein when the function of the audio device is switched to a function of playing the audio source of the mobile phone device, the control means of the external adapter controls the mobile phone device to automatically start playing of the audio source performed by the mobile phone device.

10. The audio apparatus according to claim 8, wherein when the function of the audio device is switched to a function other than a function of playing the audio source of the mobile phone device, the control means of the external adapter controls the mobile phone device to automatically stop playing of the audio source performed by the mobile phone device.

11. The audio apparatus according to claim 8, wherein when a power source of the audio device is turned OFF, the control means of the external adapter automatically stops playing of the audio source performed by the mobile phone device.

12. The audio apparatus according to claim 8, wherein when the control means of the external adapter allows the mobile phone device to play music, newer pieces of music in terms of the time when being taken into the mobile phone device are sequentially played in order.

13. The audio apparatus according to claim 8, wherein
the external adapter includes a database of an audio source, and
a music list taken in the database is compared with a music wished to be purchased, and when the music wished to be purchased has been already purchased, that effect is informed.

14. The audio apparatus according to claim 8, further comprising:
selection means arranged to select validity or invalidity of the operation of the external adapter for changing the state of the audio device.

15. An external adapter connected to an audio device and arranged to supply a signal from a mobile phone device to the audio device, the external adapter comprising:
control means arranged to change a function or a state of the audio device in accordance with a change in a state of the mobile phone device.

16. The external adapter according to claim 15, wherein the change in the function or the state of the audio device is turning ON and OFF of a power source to the audio device or playing or stopping of an audio source of the mobile phone device.

17. An external adapter connected to an audio device and arranged to supply a signal from a mobile phone device to the audio device, the external adapter comprising:
a control unit arranged to change a function or a state of the mobile phone device in accordance with a change in a state of the audio device.

18. The external adapter according to claim 17, wherein the change in the function or the state of the mobile phone device is playing or stopping of an audio source of the mobile phone device or turning ON and OFF of a power source to the mobile phone device.

19. The external adapter according to claim 17, wherein while music is played by way of an audio source of the mobile phone device, when the mobile phone device receives an incoming call, the control means of the external adapter changes a genre of a melody for a ringtone of the mobile phone device into an audio source different from a genre of the playing music.

20. An audio apparatus comprising:
an audio device arranged to supply an audio signal to a speaker to play an audio;
an external adapter connected to the audio device; and
a mobile phone device detachably mounted to the external adapter,
wherein the audio device plays, via the external adapter, an audio signal from the mobile phone device, and
wherein the external adapter includes a control unit, and in conjunction with mounting and detachment of the mobile phone device with respect to the external adapter, the control unit changes a state of the audio device.

21. An audio apparatus comprising:
an audio device arranged to supply an audio signal to a speaker to play an audio;
an external adapter connected to the audio device; and
a mobile phone device detachably mounted to the external adapter,
wherein the audio device plays, via the external adapter, an audio signal of an audio source from the mobile phone device, and
wherein the external adapter includes a control unit, and in conjunction with a change of a function of the audio device, the control unit changes a state of the mobile phone device.

22. An external adapter connected to an audio device and arranged to supply a signal from a mobile phone device to the audio device, the external adapter comprising:
a control unit arranged to change a function or a state of the audio device in accordance with a change in a state of the mobile phone device.

23. An external adapter connected to an audio device and arranged to supply a signal from a mobile phone device to the audio device, the external adapter comprising:
a control unit arranged to change a function or a state of the mobile phone device in accordance with a change in a state of the audio device.
